(19) United States
(12) Patent Application Publication
(10) Pub. No.: US 2008/0173000 A1
(43) Pub. Date: Jul. 24, 2008

(54) PTO DRIVEN IMPLEMENT AND INTERCHANGE SYSTEM

(75) Inventors: Michael Lee Skinner, Urbana, IL (US); Valentin Ion Prisecaru, Urbana, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MOE Industries, Urbana, IL (US)

(21) Appl. No.: 11/625,913

(22) Filed: Jan. 23, 2007

(51) Int. Cl. A01D 34/00

(52) U.S. Cl. 56/16.9

(57) ABSTRACT

The invention provides a power take-off from a lawn mower, through a flexible drive shaft cable, to utilize lawn maintenance accessories. The power take-off allows the accessories (e.g. edgers and trimmers) to draw power from the lawn mower's engine. Flexible drive shafts provide rotary power transmission along curved, non-linear axes. The user can engage or disengage the accessory through use of an electrical or mechanical clutch. The clutch connects the lawn mower engine drive shaft to the flexible drive shaft so that they can either be locked together and spun at the same speed, or decoupled and spun at different speeds. Engaging the clutch transfers power from the lawn mower engine to the flexible drive shaft. Disengaging the clutch stops the power transfer, but allows the lawn mower engine to continue turning. The invention provides power take-off for several pieces of lawn care equipment including weed trimmers, hedge trimmers, edgers, chainsaws, and blowers. These accessories are attached to the flexible drive shaft cable through a variety of connectors including a four-point star connector.

### FIELD OF THE INVENTION

The present invention is directed to lawn care and lawn maintenance equipment generally, and more specifically to lawn mowers with the capability to power accessory lawn maintenance tools.

### BACKGROUND OF THE INVENTION

Lawn care and maintenance equipment of various types, such as lawn mowers, edgers, trimmers, blowers, etc., are used to perform a variety of tasks. Generally, many of these devices include self-contained power sources such as an engine or a motor powered by various fuels, electricity, or batteries. These power sources add an additional cost to each piece of equipment and require the use of additional materials, labor and expenses for construction, use and maintenance. For example, many of these engines require oil, other chemical lubricants, and routine maintenance. Use of such materials also creates disposal and waste problems.

One type of such lawn care and maintenance equipment is self-powered lawn mowers including riding mowers and walking mowers. Such mowers are generally equipped with a self-contained power source, typically rotary engines or motors with a cutting blade attached to a shaft of the engine. The engine shaft of these mowers rotates to drive the blade for cutting or mulching grass and other lawn coverings.

Lawns are typically manicured by first trimming grass around trees or fences with a weed trimmer and then riding or pushing a lawn mower to cut the remainder of the grass. Conventional lawn mowers have limited maneuverability such that use of a separate trimming apparatus to cut all of the grass or weeds close to obstacles cannot be avoided.

Therefore, it is desirable to have lawn care accessories (e.g. edgers, trimmers, etc.) to be attached and powered by lawn mowers to save time and costs in lawn maintenance and power consumption. Furthermore, it is desirable to have the ability to attach lawn equipment to a lawn mower to compensate for the mower's lack of maneuverability.

### BRIEF SUMMARY OF THE INVENTION

The invention provides a power take-off from a lawn mower, through a flexible drive shaft cable, to utilize lawn maintenance accessories. The power take-off allows the accessories (e.g. edgers and trimmers) to draw power from the lawn mower's engine. Flexible drive shafts provide rotary power transmission along curved, non-linear axes. The user can engage or disengage the accessory through use of an electrical or mechanical clutch. The clutch connects the lawn mower engine drive shaft to the flexible drive shaft so that they can either be locked together and spun at the same speed, or decoupled and spun at different speeds. Engaging the clutch transfers power from the lawn mower engine to the flexible drive shaft. Disengaging the clutch stops the power transfer, but allows the lawn mower engine to continue turning. The invention provides power take-off for several pieces of lawn care equipment including weed trimmers, hedge trimmers, edgers, chainsaws, and blowers. These accessories are attached to the flexible drive shaft cable through a variety of connectors including a four-point star connector.

### BRIEF DESCRIPTION OF THE SEVERAL VIEWS OF THE DRAWING(S)

FIG. 1 is drawing of a lawn mower connected to a lawn maintenance tool through its power take-off and flexible drive shaft.

FIG. 2 is a detailed drawing of the interior of the lawn mower.

FIGS. 3a and 3b are detailed drawings of the lawn mower, the flexible drive shaft, and the connector between the flexible drive shaft and the lawn maintenance tool.

FIG. 4 is a detailed drawing of an Edger, a lawn maintenance tool.

FIGS. 5a and 5b are detailed drawings of a Blower, a lawn maintenance tool.

FIGS. 6a and 6b are detailed drawings of a Hedge Trimmer, a lawn maintenance tool.

FIG. 7 is a detailed drawing of a Chainsaw, a lawn maintenance tool.

FIGS. 8a and 8b are detailed drawings of a Weed Trimmer, a lawn maintenance tool.

FIG. 9 is a detailed drawing of an Electric Clutch.

FIG. 10 is a drawing of a lawn mower with two power take-offs connected to two lawn maintenance tools, each connected to a power take-off and flexible drive shaft.

FIG. 11 is a detailed drawing of the interior of the lawn mower containing two power take-offs.

FIG. 12 is a detailed drawing of the interior of the lawn mower using a gear system to drive the power-take-off and the flexible drive shaft.

FIG. 13 is a detailed drawing of the interior of the lawn mower using a gear system to drive a power-take-off and flexible drive shaft that is accessible from the side of the lawn mower.

FIG. 14 is a drawing of a riding lawn mower connected to a lawn maintenance tool through its power take-off and flexible drive shaft.

### DETAILED DESCRIPTION OF THE INVENTION

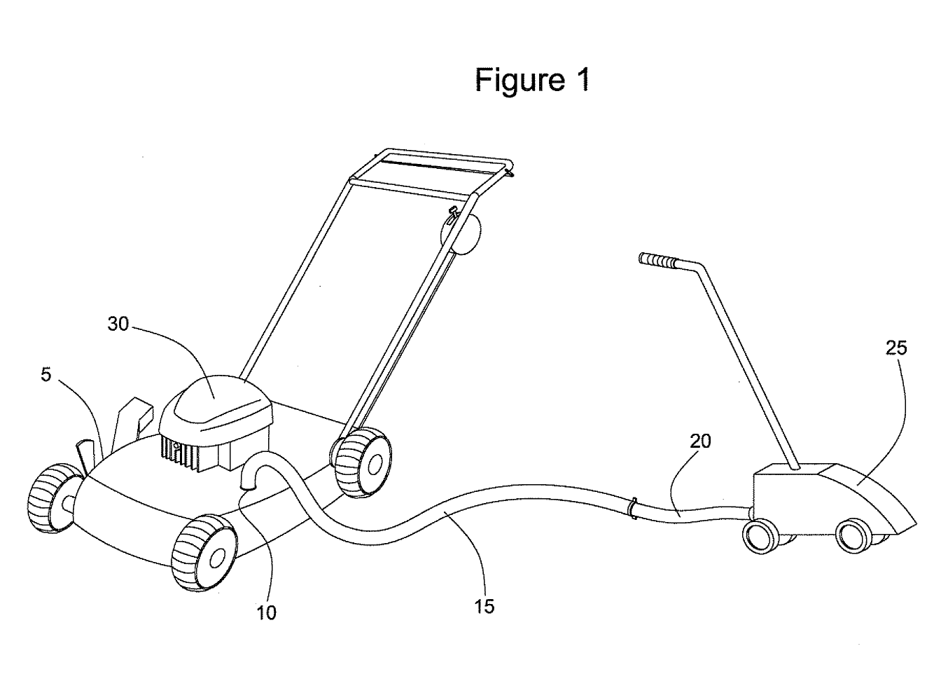

Referring now to the figures, FIG. 1 is a drawing of a lawn mower 5 connected to an Edger 25, an accessory lawn maintenance tool, through its power take-off (PTO) 10 and flexible drive shaft 15, The lawn mower shown is a typical rotary lawn mower having a main frame with four wheels that allow it to be pushed or driven across a lawn. The engine 30 of the lawn mower 5 drives power to the Edger 25 through the power take-off 10, flexible drive shaft 15, and finally to the power cable 20 of the Edger.

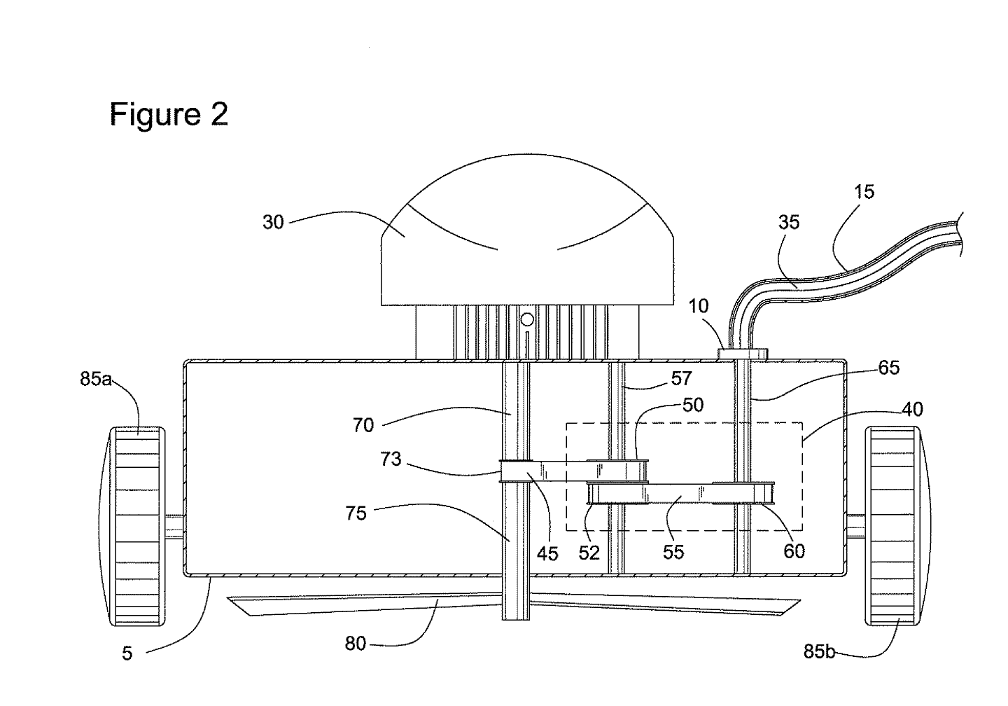

FIG. 2 is a detailed drawing of the interior of the lawn mower 5. First, the engine 30 drives the engine drive shaft 70, which in turn drives the lawn mower blade 80. Note, the engine can be a 4-stroke gas powered engine with horsepower ranging from 4 hp to 7 hp. However, the present invention can also support a 2-stroke gas powered engine as well as an electric motor with drive shaft powering the mower blade. The engine or electric motor provides a speed of 1 mph to 3.5 mph for the mower. In conventional lawn mower internal combustible engines, the drive shaft 70 has a bottom end extending downward beneath the frame to the blade and a top end is connected to the starter mechanism. Furthermore, the lawn mower must be regularly maintained so that oil sufficiently lubricates its engine.

The drive pulley system 40 transfers power from the engine drive shaft 70 to the flexible drive shaft 35. An endless belt 45 (that is connected 73 to the engine drive shaft 70), transfers power from the engine drive shaft 70 to the double pulley system 40. The present invention supports many types of belts including premium, heavy duty Kevlar, and regular types of belts. Specifically, the endless belt 45 transfers power from the engine drive shaft 70 to the coupling pulleys (50, 52) of the double pulley system 40. The coupling pulleys (50, 52) are held in place by a support shaft 57. Next, the coupling pulleys (50, 52) drive another endless belt 55 to transfer power to the drive pulley 60. Finally, the drive pulley 60 transfers power to a drive shaft 65 and finally to the power take-off 10 and the flexible drive shaft 35. The present invention supports both V-Belt and Flat Belt pulleys.

In addition, FIG. 2 shows that the flexible drive shaft 35 is contained within the flexible drive shaft cable 15. The present invention supports flexible drive shafts made of carbon steel, stainless steel, tempered steel, music wire, rocket wire, bronze alloys, copper alloys, or other similar materials. The flexible cabling can be made from plastic, vinyl, or other similar materials. These materials not only describe the flexible drive shaft 35 and its cable 15 from the PTO 10 but also the flexible drive shafts and cablings for the lawn care accessories. Note, wheels of the lawn mower are also depicted in FIG. 2 (85a, 85b).

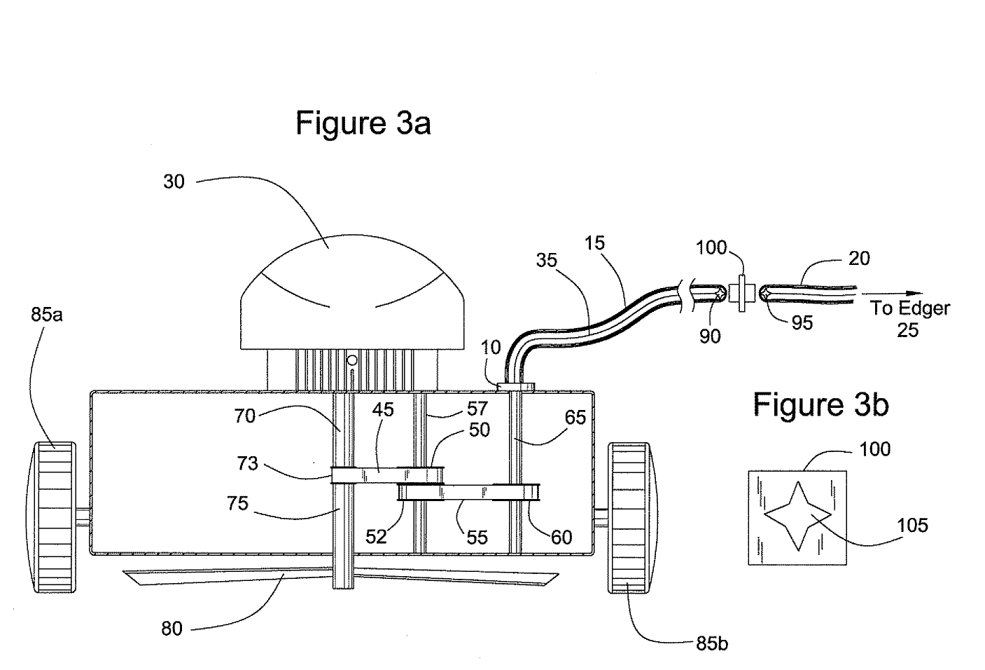

FIGS. 3a and 3b are detailed drawings of the lawn mower 5 and the connector 100 between the flexible drive shaft 35 and the Edger 25 lawn maintenance tool. In FIG. 3a, the flexible drive shaft cable 15 is a flexible four-point star cable 90 that attaches to a connector 100. Similarly, the Edger power cable 20 is also a four-point star cable 95 and attaches to the connector 100. In FIG. 3b, the front view of the connector 100 reveals a four point star interface 105 for both the flexible drive shaft cable 35 and Edger power cable 20 to attach. However, the present invention can support any type of connector between the flexible drive shaft cable 35 and any lawn care accessory power cable 20 and any type flexible drive shaft cable 35.

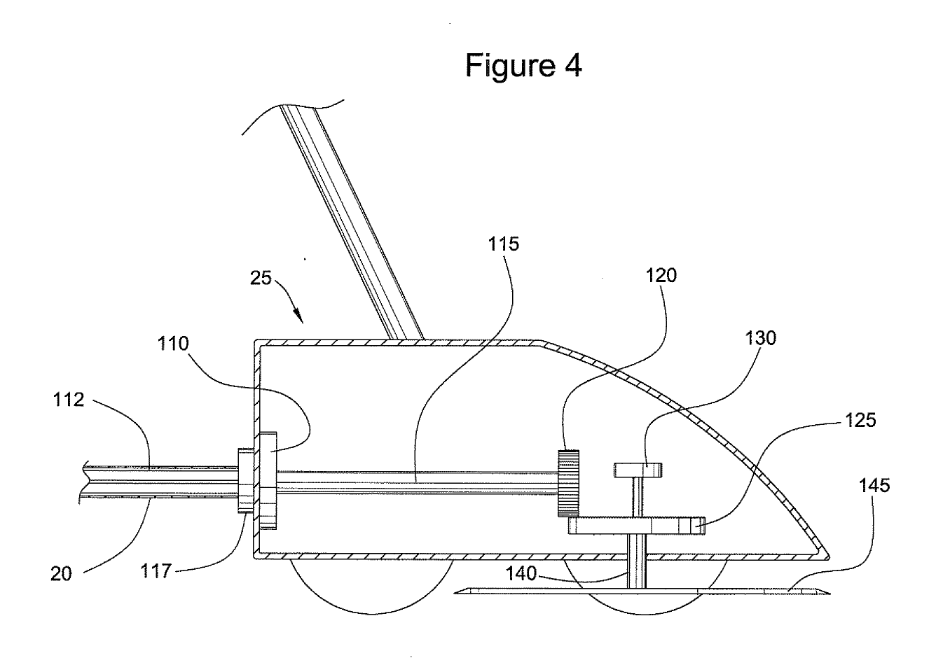

FIG. 4 is a detailed drawing of an Edger 25, a lawn maintenance tool. The Edger 25 along with every lawn care accessory attached to the PTO, has simple cost effective interior mechanics. The PTO eliminates the need for the lawn care accessory to have its own engine or power source. In FIG. 4, the Edger power cable 20 contains the Edger flexible drive shaft 112. This attaches to the Edger power connector 117. A bearing 110 is attached to the Edger power connector from the inside of the Edger 25. The bearing can be any roller bearing such as a ball bearing. The Edger flexible drive shaft 112 turns the Edger drive shaft 115, which turns a first gear 120. This first gear 120 transfers power to a second gear 125 perpendicular to the first gear 120. This second gear then powers a drive shaft 140. The first and second gears (120,125), as well as any gear of the lawn mower or lawn care accessories, can be of any type including bevel, angular, bevel, and crown gears. Finally, the drive shaft 140 turns the Edger's blade 145.

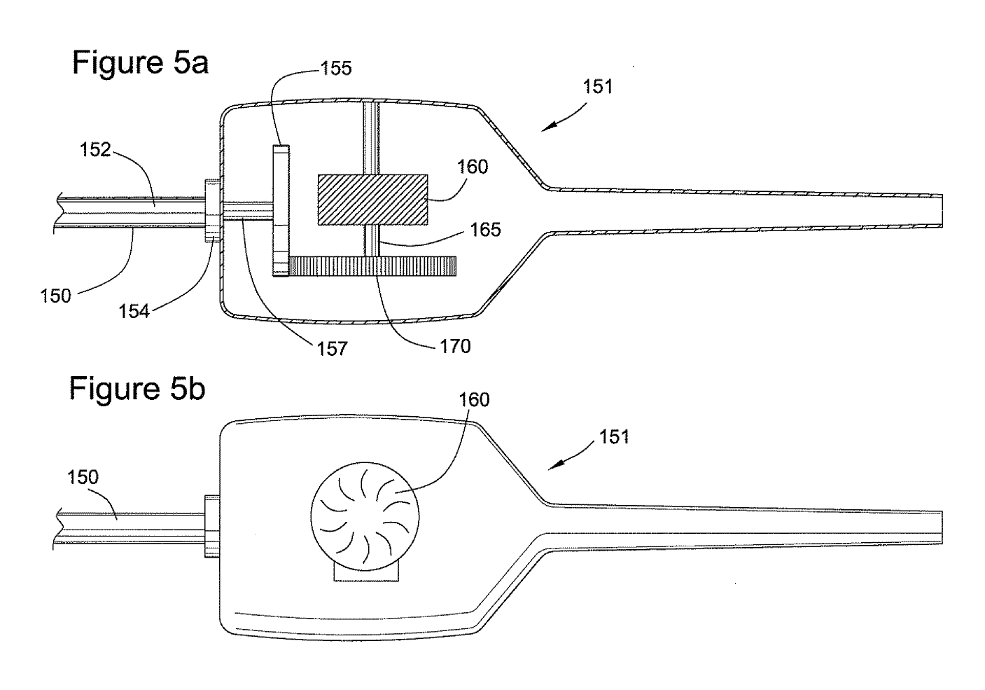

FIGS. 5a and 5b are detailed drawings of a Blower 151, a lawn maintenance tool. In FIG. 5a, the Blower power cable 150 contains the Blower flexible drive shaft 152. The Blower power cable 150 attaches to the power connector 154. The Blower flexible drive shaft 152 turns the drive shaft 157. Next, the drive shaft 157 turns the first gear 155, which in turn transfers power to the second gear 170 that is perpendicular to it. The second gear 170 turns the drive shaft 165 that drives the Blower Mechanism 160. FIG. 5b is a detailed front view drawing of the Blower 151. It illustrates details of the Blower Mechanism 160.

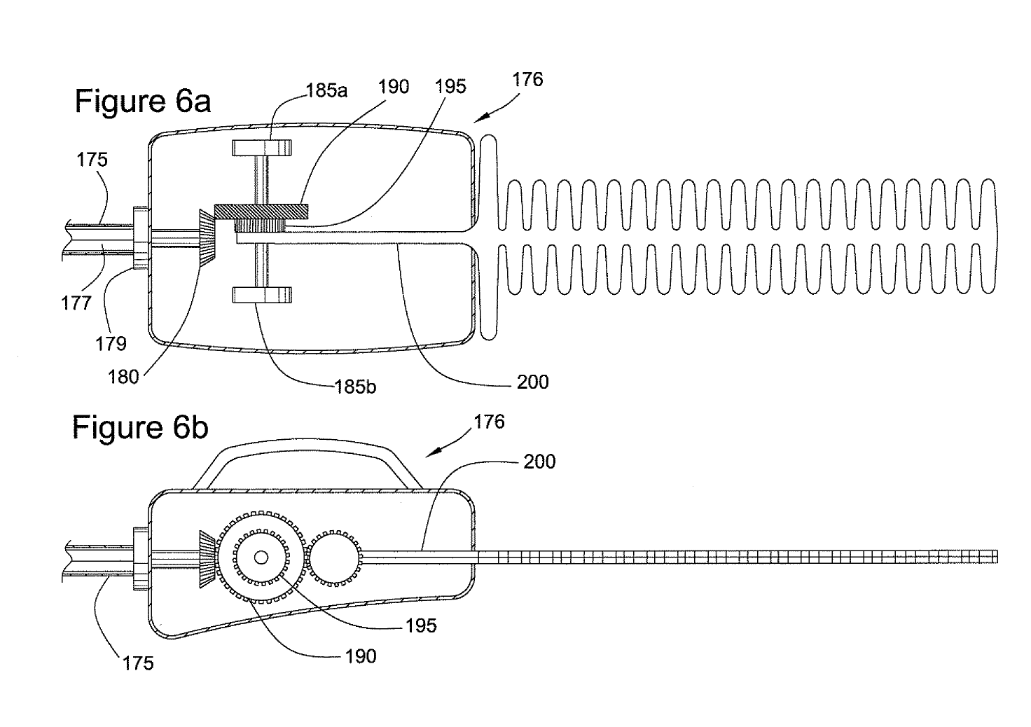

FIGS. 6a and 6b are detailed drawings of a Hedge Trimmer 176, a lawn maintenance tool. In FIG. 6a, the power cable 175 contains the flexible drive shaft 177. The power cable 175 attaches to the power connector 179. The flexible drive shaft 177 turns the first gear 180, which in turn transfers power to the second gear 190 (perpendicular to the first gear 180). The second gear 190 powers the Hedge Trimmer Drive Mechanism 195. Finally, the Drive Mechanism powers the Hedge Trimmer blade 200. In addition, there are two bearings (185a, 185b) on either side of the Drive Mechanism 195. FIG. 6b shows the Side View of the Hedge Trimmer 176.

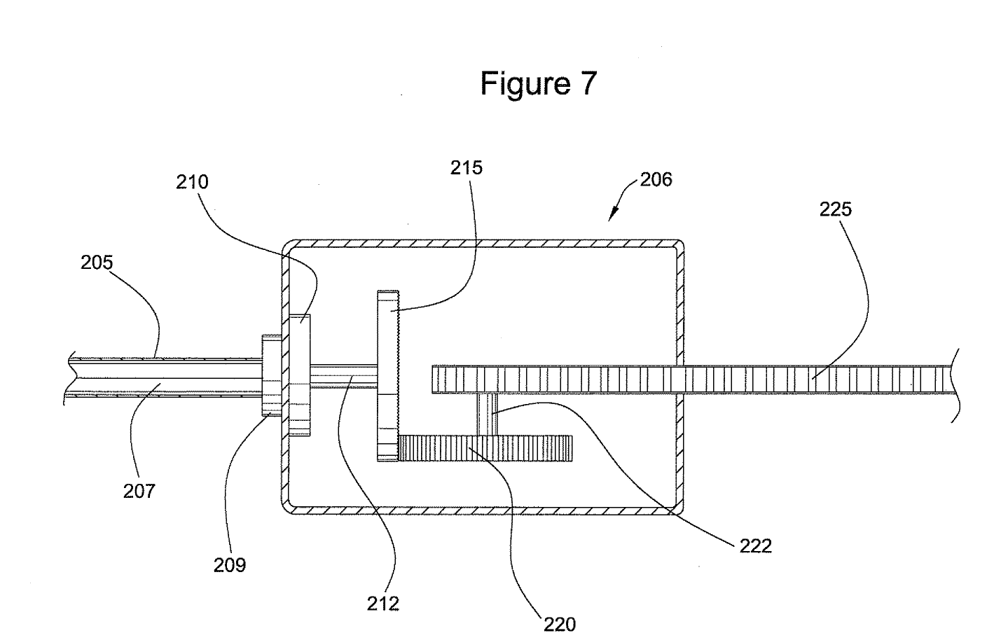

FIG. 7 is a detailed drawing of a Chainsaw 206, a lawn maintenance tool. In FIG. 7, the Chainsaw power cable 205 contains a flexible drive shaft 207. The power cable attaches to the power connector 209. There is a bearing 210 inside the Chainsaw 206, attached to the connector. The flexible drive shaft 207 turns the drive shaft 212 of the Chainsaw 206. The drive shaft 212 turns the pinion 215. The pinion 215 transfers power to the power gear 220. Finally, the power gear, through the drive shaft 222, runs the Chainsaw blade 225.

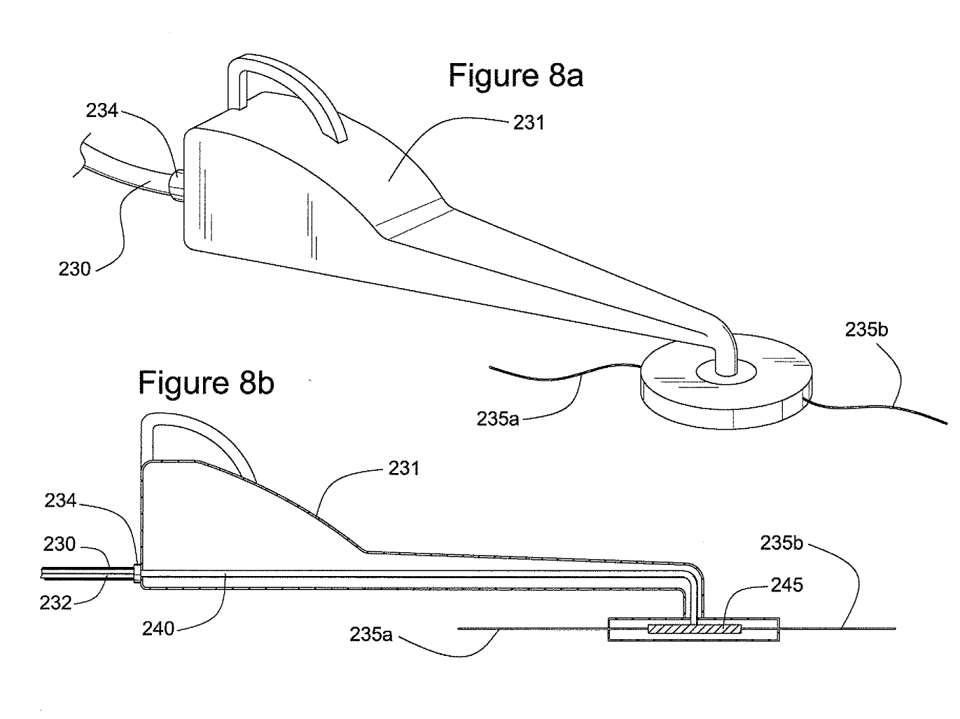

FIGS. 8a and 8b are detailed drawings of a Weed Trimmer 231, a lawn maintenance tool. FIG. 8a shows a Weed Trimmer 231 with power cable 230 and blades (235a, 235b). FIG. 8b is a detailed side view drawing of the Weed Trimmer 231. The power cable 230 contains a flexible drive shaft 232. First, the power cable 230 attaches to the power connector 234. Next, the power cable's flexible drive shaft 232 turns the flexible drive shaft 240 within the Weed Trimmer 231. Finally, the flexible drive shaft 240 powers the Blade Mechanism 245 to rotate the blades (235a, 235b).

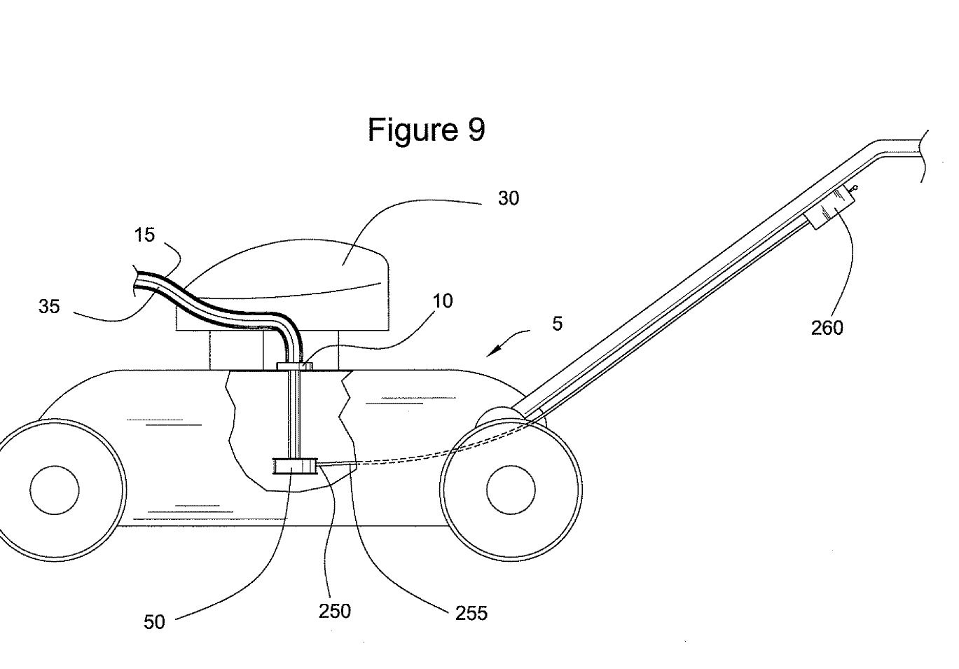

FIG. 9 is a detailed drawing of the electric clutch. The clutch that controls the power take-off 10 is engaged by a toggle switch 260 near the lawn mower handle. A cable 255 runs from the toggle switch 260 to the electric clutch 250 attached to the coupling pulleys (50, 52). Toggling the switch 260 in one direction engages the clutch and allows the flexible drive shaft cable 15 to run lawn maintenance accessories. Toggling the switch 260 in the opposite direction disengages the clutch and shuts down the power take-off 10.

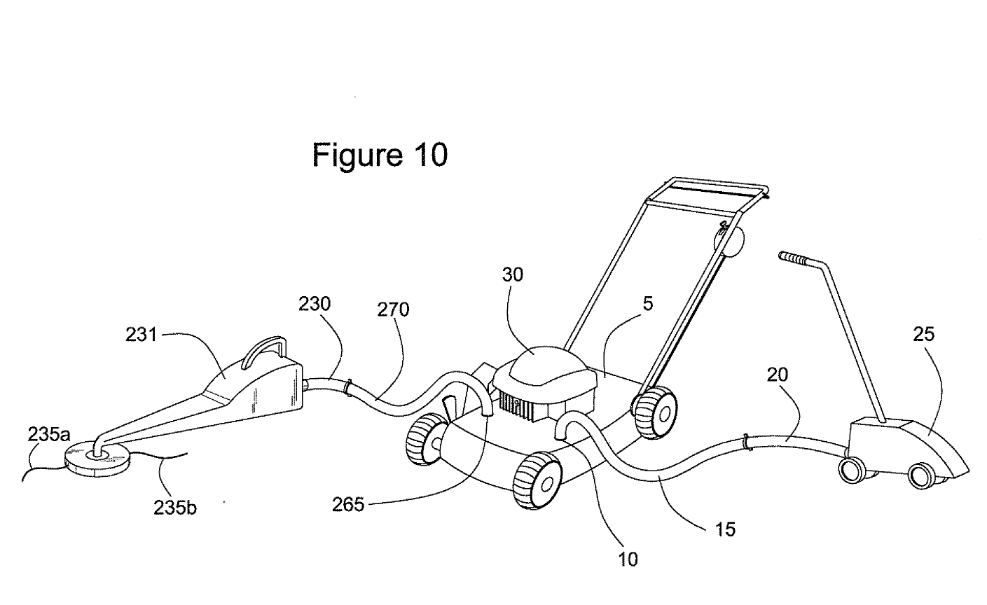

FIG. 10 is drawing of a lawn mower 5 with two power take-offs (10, 265) connected to two lawn maintenance tools (25, 231) each connected to a power take-off (10, 265) and flexible drive shaft (15, 270). A need may occur in maintaining large grounds, such as parks or golf courses, where it would be necessary to utilize two accessory lawn tools from one lawn mower. For example, one person may use an Edger while another person uses a trimmer. The ability to implement two lawn care tools simultaneously reduces time and cost, and increases efficiency in the work of groundskeepers caring for large lawns (i.e. parks and golf courses). Similar to FIG. 1, FIG. 10 shows an Edger 25 attached to a PTO 10 through the flexible drive shaft cable 15 and the Edger power cable 20. However, in addition, there is a second PTO 265 located on the lawn mower 5. This second PTO 265 is connected to a Weed Trimmer 231 through a second flexible drive shaft cable 270 and the Weed Trimmer power cable 230.

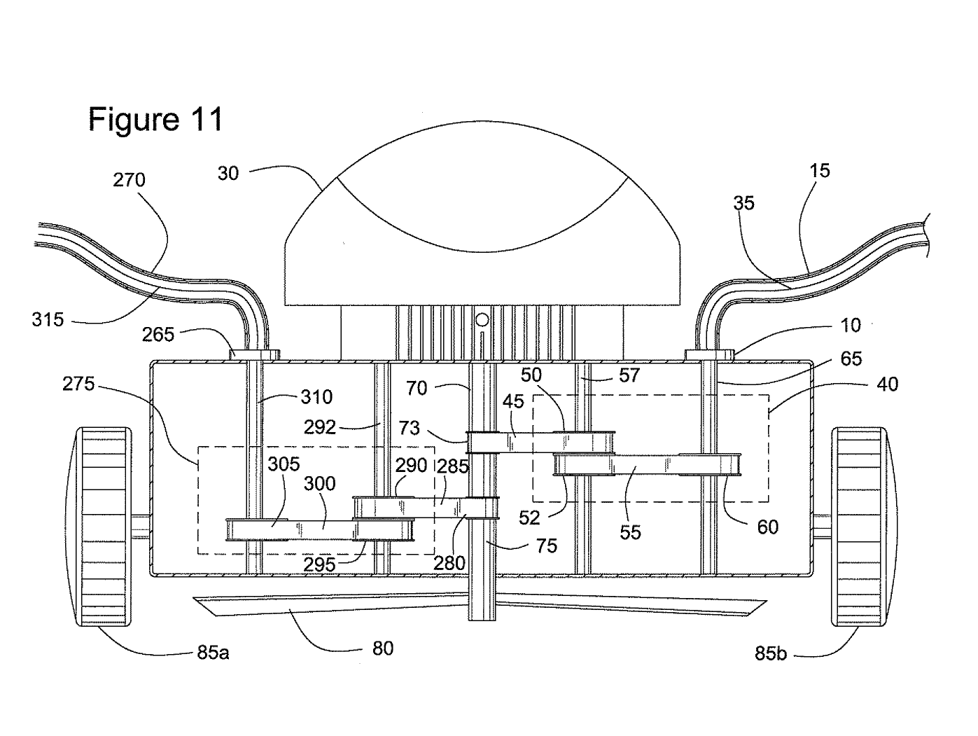

FIG. 11 is a detailed drawing of the interior of the lawn mower containing two power take-offs (10, 265). The double pulley systems (40, 275) for both power take-offs (10, 265) mirror each other. The first double pulley system 40 is similar to the one pictured in FIG. 2. The second pulley system 275 has an endless belt 285 that transfers power from the engine drive shaft 70 to the coupling pulleys (290, 295) of the second pulley system 275. The endless belt 285 is attached to the engine drive shaft 70 by a connector 280. The coupling pulleys (290, 295) are held in place by a support shaft 292. Another endless belt 300 transfers power from the coupling pulleys (290, 295) to the drive pulley 305. Next, the drive pulley 305 turns a drive shaft 310. Finally, the drive shaft 310 powers the second power take-off 265 and its flexible drive shaft 315.

The double pulley system 40 can be replaced by a gear system. As is well known in the art, pulleys operate in the same direction as each other when connected through a belt. However, gears operate in the opposite direction of each other. Replacing the double pulley system 40 with a gear system provides the present invention the ability to have the flexible drive shaft 35 and engine drive shaft 70 rotate in opposite directions. Furthermore, a gear system can allow the flexible drive shaft 35 to rotate faster or slower than the engine drive shaft 70.

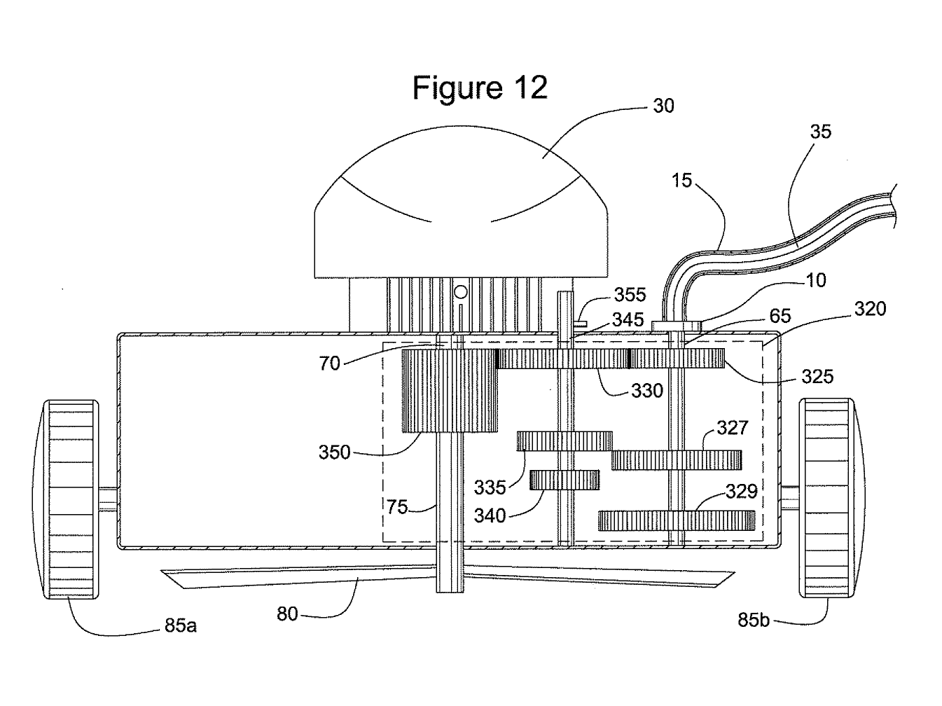

FIG. 12 is a detailed drawing of the interior of the lawn mower using a gear system to drive the power-take-off 10 and the flexible drive shaft 35. In this embodiment of the present invention, the double pulley system pictured in FIGS. 2 and 11 is replaced by a gear system 320. The gear system 320 provides more features to the PTO 10 and flexible drive shaft 35, but at a higher cost than the double pulley system 40. In this embodiment, the engine drive shaft 70 turns the first gear 350. This first gear then powers one of three gears (330, 335, 340) as selected by the lawn mower operator. The lawn mower operator can select any one of the three gears by moving the gear selector 355 vertically up and down. The gear selector is similar to a mechanical clutch. As the operator shifts the gear selector up and down, she can choose different gears to run the flexible drive shaft 35 at different speeds. For example in this embodiment, an operator can shift the gear selector to its highest position and choose the top gear 330. The top gear 330 being the largest gear results in rotating the flexible drive shaft 35 at the slowest speed. The top gear 330 gear selector will drive the top gear 325 of the flexible drive shaft (65, 35). Alternatively, an operator shifting the gear selector 355 down to the middle position can choose the middle gear 335. This gear is smaller than the top gear 330 resulting in rotating the flexible drive shaft 35 at a higher speed. The middle gear 335 of the gear selector engages the middle gear of the flexible drive shaft (65, 35). Finally, the operator may shift the gear selector to its lowest position and choose the bottom and smallest gear 340. This gear will drive the flexible drive shaft 35 fastest. The bottom 340 gear of gear selector engages the bottom gear of the flexible drive shaft (65, 35). Once the operator selects one of the shifting gears (330, 335, and 340) then it transfer power to one of the flexible drive shaft gears (325, 327, and 329). Subsequently, one of these gears (325, 327, and 329) powers the flexible drive shaft 35 for the PTO 10.

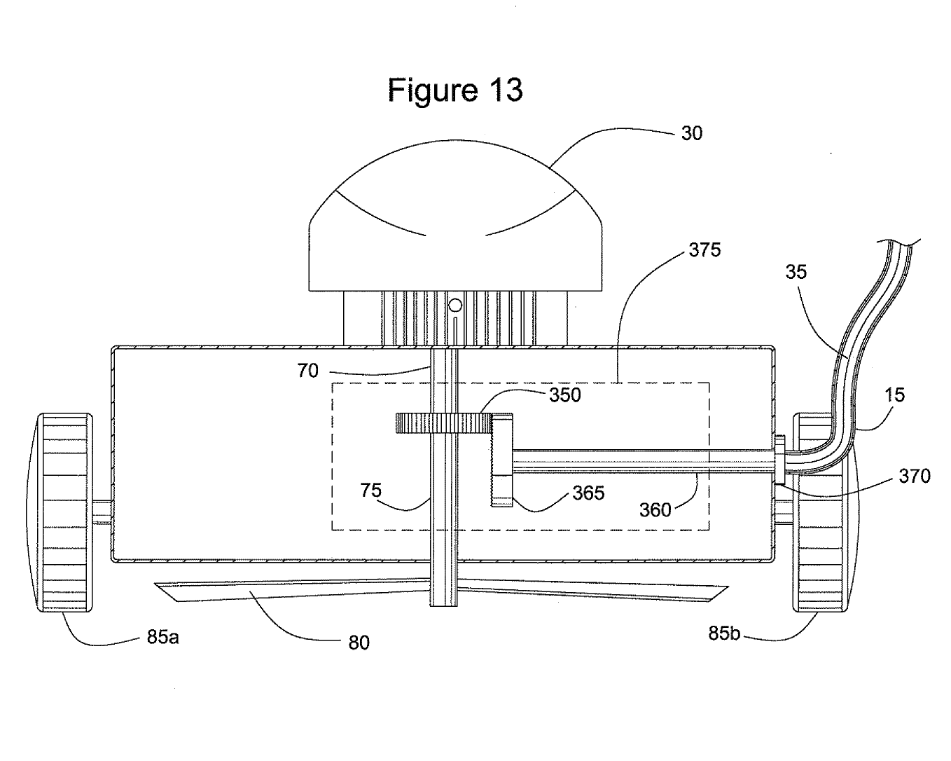

FIG. 13 is a detailed drawing of the interior of the lawn mower using a gear system 375 to drive a power-take-off and flexible drive shaft that is accessible from the side of the lawn mower. In this embodiment of the invention, the gear system 375 provides access to the PTO 370 and flexible drive shaft 35 from the side of the lawn mower. First, the engine drive shaft 70 turns the first gear 350. Next, the first gear 350 powers the second gear 365 aligned perpendicular to the first gear 350. Finally, the second gear 365 powers the drive shaft 360 which in turn powers the flexible drive shaft 35 from the side accessible PTO 370.

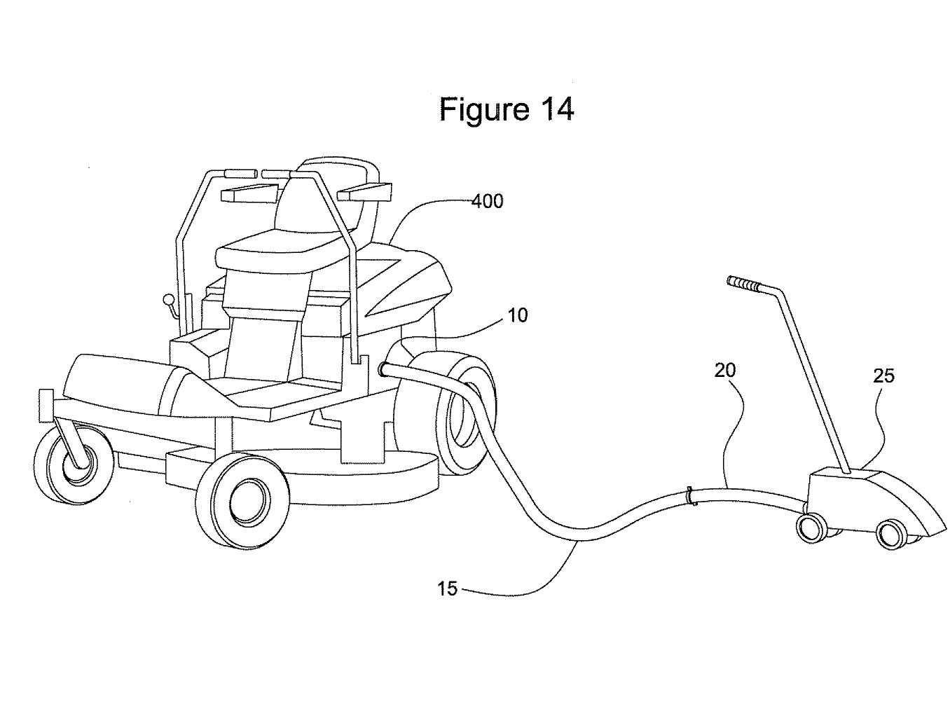

FIG. 14 is a drawing of a riding lawn mower connected to a lawn maintenance tool through its power take-off and flexible drive shaft. This embodiment of the present invention is similar to the embodiment depicted in FIG. 1. However, in this embodiment the power take-off 10 and flexible drive shaft cable 15 are attached to a riding lawn mower 400. In all other aspects this embodiments is similar to the embodiments pictured and described in FIGS. 1-13.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A rotary lawn mower capable of powering accessory lawn maintenance tool comprising:
an engine contained within an engine housing on a platform;
a drive shaft connected to and powered by the engine contained within the engine housing;
front and rear wheels attached to and supporting the engine housing and platform;
a cutting blade rotatably attached to the engine to be turned thereby;
one or more power take-offs connected to the engine housing and platform;
one or more flexible drive shafts attached to the power take-off through a connector, such that each flexible drive shaft can power an accessory lawn maintenance tool;
a clutch for engaging and disengaging each flexible drive shaft from the engine; and
one or more power couplings contained within the engine housing and platform, connected to the engine drive shaft to transfer power from the engine to each power take-off;
wherein the accessory lawn maintenance tool is selected from the group consisting of: an edger, a blower, a hedge trimmer, a chainsaw, and a weed trimmer.

2. The rotary lawn mower according to claim 1, wherein the cutting blade is connected to the engine drive shaft.

3. The rotary lawn mower according to claim 1, wherein the engine powers each flexible drive shaft through the power coupling.

4. The rotary lawn mower according to claim 1, wherein the power coupling is a double pulley system comprising:
an first endless belt connected to the engine drive shaft and transferring power from the engine drive shaft to a first coupling pulley supported by a shaft connected to the engine housing and platform;
a second coupling pulley supported by the same shaft supporting first coupling pulley, transfers power from first coupling pulley to a second endless belt;
wherein the second endless belt transfers power from the second coupling pulley to a drive pulley that is supported by a drive shaft connected to the engine housing and platform;
wherein the drive shaft supporting the drive pulley is connected to the power take-off and powers the flexible drive shaft.

5. The rotary lawn mower according to claim 1, wherein the power coupling is a gear system comprising:
a drive gear connected to the engine drive shaft, wherein the drive gear transfers power from the engine drive shaft to one of a plurality of shifting gears;
a gear selector that selects one of a plurality of shifting gears; and
wherein one of a plurality of shifting gears transfers power from the drive gear attached to the engine drive shaft to one of a plurality of drive gears attached to a drive shaft powering the power take-off and flexible drive shaft.

6. The rotary lawn mower according to claim 1, wherein the power coupling is a gear system comprising:
a first drive gear connected to the engine drive shaft wherein the drive gear transfers power from the engine drive shaft to a second drive gear;
wherein the second drive gear is perpendicular to the first drive gear;
wherein the second drive gear transfer power from the first drive gear to a drive shaft;
wherein the drive shaft transfers power from the second drive gear to the power take-off and flexible drive shaft.

7. The rotary lawn mower according to claim 1, wherein the clutch can be electrically shifted to one of two positions wherein:
the first position engages each power coupling allowing the engine to supply power to the cutting blade and each flexible drive shaft; and
the second position disengages each power coupling not allowing the engine to supply power to each flexible drive shaft but allowing the engine to continue supplying power to the cutting blade.

8. The rotary lawn mower according to claim 1, wherein the clutch can be mechanically shifted to one of two positions wherein:
the first position engages each power coupling allowing the engine to supply power to the cutting blade and each flexible drive shaft; and
the second position disengages each power coupling not allowing the engine to supply power to each flexible drive shaft but allowing the engine to continue supplying power to the cutting blade.
